(19) United States
(12) Patent Application Publication
(10) Pub. No.: US 2025/0033222 A1
(43) Pub. Date: Jan. 30, 2025

(54) PNEUMATIC COUPLING SYSTEM

(71) Applicant: IMPAQT ROBOTICS PRIVATE LIMITED, Chennai (IN)

(72) Inventors: Anuj BIHANI, Chennai (IN); Anandan P, Chennai (IN); R Nagamuthu KUMARAN, Chennai (IN)

(21) Appl. No.: 18/716,861

(22) PCT Filed: Dec. 6, 2022
(86) PCT No.: PCT/IB2022/061814

§ 371 Date: Jun. 5, 2024

(30) Foreign Application Priority Data
Dec. 8, 2021 (IN) 202141057045

(51) Int. Cl. B25J 15/00; B25J 13/00; B25J 15/06; B25J 19/00

(52) U.S. Cl. CPC B25J 15/0052; B25J 13/006; B25J 15/0658; B25J 19/0033

(57) ABSTRACT

The present disclosure provides a pneumatic coupling system for coupling a mechanical arrangement to one or more end effectors. The pneumatic coupling system comprises a central body providing a top face, a first fastening interface provided in the top face of the central body to allow for releasably coupling a docking plate of the mechanical arrangement thereat, one or more arms, a second fastening interface provided in the said one of the one or more arms to allow for releasably coupling a docking plate of one of the one or more end effectors thereat, a dispensing port associated with the at least one of the one or more arms, a fluid manifold having a fluid inlet port configured to receive a pneumatic fluid and a fluid circuit for each of the one or more arms, disposed in fluid communication with the fluid manifold to receive the pneumatic fluid therefrom.

### FIELD OF THE INVENTION

The present invention relates generally to pneumatic coupling systems, and more specifically, to a pneumatic coupling system for coupling a mechanical arrangement to one or more end effectors.

### BACKGROUND OF THE INVENTION

In recent times, there has been an increased focus on developing small and versatile mechanical devices or tools (such as, robotic arms or other end effectors) that may switch between tasks easily. Such mechanical devices or arms usually have a low weight to enable a single worker to operate between working stations and are simple enough to be programmed by low skilled workers. However, they have a limited payload capacity. A typical application is to use a mechanical arrangement in combination with a tool or end effector; for example, a gripping tool, for small scale manufacturing processes, such as simple object moving tasks (e.g., pick and drop). The tool, such as a pneumatic gripper, is usually connected to the mechanical arrangement via a coupling adapted specifically thereto. However, if another different tool is required, such as a suction gripper, then another different coupling is often added to the mechanical arrangement. Thus, increases the complexity of the coupling as more valves and components are required to accommodate and control the different tools and consequently increases the weight and associated costs of the coupling device.

Most mechanical devices such as pneumatic end effectors need multiple pneumatic lines, pneumatic valve(s), electrical lines for position sensors or switches, and electrical power for the valve(s) to actuate the pneumatic end effector. Typically, these lines are externally mounted onto the mechanical arrangement or robot and/or the pneumatic end effector. In a given mechanical system or device, there may be numerous, externally mounted pneumatic and electrical lines that may potentially be loose and disorderly. Moreover, the mechanical system may also include externally mounted pneumatic valve(s). Additionally, the externally mounted pneumatic and electrical lines may lead to a potential need for supplying externally mounted interface circuitry between the mechanical system, tools, pneumatic valve(s), and sensors. These externally mounted pneumatic and electrical lines, pneumatic vales(s), and interface circuitry can be cumbersome and unsightly and may even be a hindrance to work productivity.

To overcome the aforementioned problems, the present disclosure provides the pneumatic coupling system for coupling a mechanical arrangement to one or more end effectors.

### SUMMARY OF THE INVENTION

The present disclosure seeks to provide a pneumatic coupling system for coupling a mechanical arrangement to one or more end effectors. An aim of the present disclosure is to provide a solution that overcomes at least partially the problems encountered in prior art.

In one aspect, the present disclosure provides a pneumatic coupling system for coupling a mechanical arrangement to one or more end effectors, the pneumatic coupling system comprising:
a central body providing a top face;
a first fastening interface provided in the top face of the central body to allow for releasably coupling a docking plate of the mechanical arrangement thereat;
one or more arms, with one of the one or more arms extending from the central body along an arm axis (A);
a second fastening interface provided in the said one of the one or more arms to allow for releasably coupling a docking plate of one of the one or more end effectors thereat;
a dispensing port associated with the at least one of the one or more arms;
a fluid manifold having a fluid inlet port configured to receive a pneumatic fluid; and
a fluid circuit for each of the one or more arms, disposed in fluid communication with the fluid manifold to receive the pneumatic fluid therefrom, the fluid circuit comprising:
   a first fluid outlet line for supplying the pneumatic fluid to the one or more end effectors; and
   a second fluid outlet line for supplying the pneumatic fluid to the dispensing port.

In an embodiment, the second fastening interface is provided at a length L along the arm axis (A) from the central body, with the length L varying in a range of 1 millimetre to 1000 millimetres.

In an embodiment, wherein for each of the one or more arms:
an arm plane angle (α) of the corresponding arm axis (A) defined by rotation of the XY plane about the Z axis of the first coordinate system, varies in a range of 0 degrees to 360 degrees, and
an arm angle (β) of the corresponding arm axis (A) defined by rotation of a XZ plane about the Y axis of the first coordinate system, varies in a range of −165 degrees to +165 degrees.

In an embodiment, for each of the one or more arms, the arm axis (A) defines a Z′ axis of a second coordinate system with a X′ axis and a Y′ axis perpendicular to the Z′ axis, and a X′Z′ plane defining a plane for the second fastening interface therein, and wherein for the corresponding one of the one or more end effectors:
an end effector plane angle (α′) defined by rotation of a X′Y′ plane about the Z′ axis of the second coordinate system, varies in a range of −165 degrees to +165 degrees,
a first end effector angle (β′) defined by rotation of the X′Z′ plane about the Y′ axis of the second coordinate system, varies in a range of −165 degrees to +165 degrees, and
a second end effector angle (γ′) defined by rotation of the Y′Z′ plane about the X′ axis of the second coordinate system, varies in a range of −165 degrees to +165 degrees.

In an embodiment, for the corresponding one of the one or more end effectors, an end effector face angle (δ) defined by rotation of the corresponding one of the one or more end effectors about the Z′ axis of the second coordinate system, varies in a range of 0 degrees to 360 degrees.

In an embodiment, the dispensing port is provided in each of the at least one of the one or more arms, disposed between the central body and the second fastening interface therein.

In an embodiment, the pneumatic coupling system comprises a fluid port configured to receive a liquid fluid, and wherein the fluid circuit is configured to supply the liquid fluid to the dispensing port of the corresponding arm to be dispensed thereby.

In an embodiment, the fluid circuit further comprises:
one or more control valves associated with each of the first fluid outlet line and the second fluid outlet line to regulate the supply of the pneumatic fluid therein; and
one or more isolation valves to segregate the supply of the pneumatic fluid to the first fluid outlet line and the second fluid outlet line.

In an embodiment, the pneumatic coupling system comprises a controller; and a communication line disposing the controller in signal communication with the mechanical arrangement and one or more end effectors,
wherein the controller receives control signals indicative of operation of the mechanical arrangement via the communication line, and the controller is configured to regulate the supply of the pneumatic fluid to each of the first fluid outlet line and the second fluid outlet line based on the control signals received thereby, and
wherein the controller transmits control signals to the mechanical arrangement indicative of one or more of a current position, a current orientation of the one or more end effectors, associated therewith.

### BRIEF DESCRIPTION OF THE DRAWINGS

The present disclosure will now be described, by way of example only, with reference to the following diagrams wherein:

FIG. 1 is an illustration of an exploded perspective view of a pneumatic coupling system, in accordance with an embodiment of the present disclosure;

FIG. 2 is an illustration of a bottom perspective view of the pneumatic coupling system for operatively coupling two or more mechanical devices, in accordance with an embodiment of the present disclosure;

FIG. 3 is an illustration of an exploded perspective view of another pneumatic coupling system for operatively coupling two or more mechanical devices, in accordance with another embodiment of the present disclosure;

FIG. 4 is an illustration of a bottom perspective view of the pneumatic coupling system of FIG. 3. for operatively coupling two or more mechanical devices, in accordance with an embodiment of the present disclosure;

FIG. 5 is an illustration of a side view of the pneumatic coupling system, in accordance with an embodiment of the present disclosure;

FIG. 6 is an illustration of a bottom perspective view of the pneumatic coupling system, in accordance with an embodiment of the present disclosure;

FIG. 7 is an illustration of an exploded perspective view of the pneumatic coupling system depicting components of fluid circuit for flow of the pneumatic fluid therein, in accordance with an embodiment of the present disclosure;

FIG. 8 is an illustration of an exploded perspective view of the another pneumatic coupling system depicting components of fluid circuit for flow of the pneumatic fluid therein, in accordance with another embodiment of the present disclosure;

FIGS. 9-10 are diagrammatic representations of a first coordinate system and a second coordinate system respectively, as associated with the pneumatic coupling system for coupling the mechanical arrangement and the one or more end effectors, in accordance with various embodiments of the present disclosure;

FIGS. 11A-14B are illustrations depicting various physical configurations of different pneumatic coupling systems and corresponding tabular representations detailing configuration parameters of the respective pneumatic coupling systems, in accordance with various embodiments of the present disclosure; and

FIGS. 15A-27B are illustrations depicting various physical configurations of different pneumatic coupling systems and corresponding tabular representations detailing configuration parameters of the respective pneumatic coupling systems, in accordance with various other embodiments of the present disclosure.

### DETAILED DESCRIPTION OF EMBODIMENTS

The present disclosure provides a pneumatic coupling system for coupling a mechanical arrangement to one or more end effectors. The pneumatic coupling system refers to a type of mechanical system configured to operatively (or mechanically) coupling one or more end effectors to the mechanical arrangement. Herein, the mechanical arrangement may include, but not limited to, a robotic arm, a crane, a gantry, and the like. Further, herein, the one or more end effectors may include, but not limited to, a gripper, coat sprayer, glue dispenser, sealant dispenser, force-torque sensor, material removal tool, welding torch, collision sensor, tool changer and the like. It will be appreciated that the pneumatic coupling system may be used to couple or connect any type of mechanical device or end effector without limiting the scope of disclosure. Generally, known pneumatic coupling devices (or couplers) are configured to connect specific types of compressed air tools to a compressed air line; however, it will be appreciated that the pneumatic coupling system of the present disclosure may be used to couple or connect any type of end effectors, and allows the end effectors to be easily connected or disconnected under pressure.

Optionally, the pneumatic coupling system is a tool or end effector on its own, for example, the pneumatic coupling system is used directly for air purging applications. In such applications, the pressure or the flow rate of the purged fluid may be independent from the end effectors coupled to the pneumatic coupling system or the pneumatic coupling system may be coupled to a fluid reservoir for direct dispensing applications. Notably, in such applications, the pneumatic coupling system is enabled to achieve multiple configurations based on the required number of tools for the application and intended application orientations of each of the one or more end effectors. Alternatively stated, the pneumatic coupling system is configured to achieve a new configuration in lieu of changing any one of the multiple configuration parameters such as, but not limited to, arm length and arm angle of the pneumatic coupling system. Moreover, to effectively control the coupled one or more end effectors (or pneumatic tools) and manage its own functioning and application, the pneumatic coupling system uses an on-board electronics circuit for operation and does not rely on any external means. Moreover, the pneumatic coupling system provides an ease of attachment to the one or more end effectors and offers better reliability and maintainability with respect to conventional pneumatic couplers.

Most end effectors such as, pneumatic end effectors require multiple mechanical components such as, but not limited to, pneumatic lines, pneumatic valve(s), electrical lines (for position sensors or switches, valve(s)) for operation i.e., to actuate the pneumatic end effector. Typically, these mechanical components such as the pneumatic lines are externally mounted onto the mechanical arrangement and/or the one or more end effectors. In a given mechanical arrangement, there may be numerous, externally mounted pneumatic and electrical lines that may be loose or disorderly and may result in a cumbersome setup that potentially hinders the operation. Notably, to avoid such a cumbersome external setup, the pneumatic coupling system is configured to enable the coupling of the mechanical arrangement with the one or more end effectors in a manner such that the need for separate mechanical components or connections such as the pneumatic hoses, power lines, and communication lines required for each of the coupled one or more end effectors is removed. Beneficially, the overall construction and/or fabrication complexity of the pneumatic coupling system is reduced by the removal of need for multiple external mechanical components that are now provided internally via the pneumatic coupling system. Moreover, beneficially, the pneumatic coupling system reduces the amount of time, maintenance effort and technical support required during installation and/or replacement.

The pneumatic coupling system comprises a central body providing a top face. The central body is configured for housing a plurality of components of the pneumatic coupling system. The “central body” refers to a container, a protective exterior, or an enclosing structural element (e.g., chassis or exoskeleton) designed to enable easier handling, provide attachment points for internal mechanisms (e.g., mounting brackets for electrical components, cables and piping), and maintain cleanliness of components of the pneumatic coupling system. The central body comprises a top face for accommodating any type of component or attachment and at the same time protects the pneumatic coupling system by shielding dirt, fouling and other contaminations, or protect interior mechanisms (e.g., delicate integrated electrical wirings and fittings) from structural stress and/or potential physical, thermal, chemical, biological or radiational damages from the surrounding environment during operation. The central body is generally made up of either a metallic component such as aluminium, steel and the like or a synthetic component such as plastics including PVC, PET, and other polymers. The material of the central body is dependent on the type of operation and is generally heat resistant having high levels of toughness to effectively endure the underlying stresses in the pneumatic coupling system during operation.

The pneumatic coupling system further comprises a first fastening interface provided in the top face of the central body to allow for releasably coupling a docking plate of the mechanical arrangement thereat. Herein, the first fastening interface refers to a fastening mechanism configured to releasably or detachably couple the docking plate with the top face of the pneumatic coupling system. In general, the term “fastening interface” refers to a either a fastener or a fastener provision, configured to mechanically join or couple two or more objects (or mechanical devices) together. The fastening interface is used to create non-permanent couplings; that is, couplings that can be removed or dismantled without damaging the joining components. The fastening interface includes at least one of, but is not limited to, bolts, anchor bolts, screws, clamps, clasps, clips, flanges, nails, pegs, nuts, pins, rivets, snap fastener, snap-fits and the like. Optionally, the fastening interface comprise an application of external attractive force, such as with magnets, vacuum (like suction cups), or even friction (like sticky pads).

Throughout the present disclosure, the term “docking plate” refers to a universal plate (including a customized plate) configured to accommodate the mechanical arrangement and enable a mechanical coupling between the pneumatic coupling system and the mechanical arrangement. Generally, the docking plate is a disc or plate having a defined thickness, wherein the disc comprises at least one of a plurality of holes or protrusions for effectively accommodating the mechanical arrangement. For example, the docking plate is a universal plate, having multiples grids of holes spaced at equal or unequal intervals depending upon the implementational requirements., which provides space for many mechanical connections. The docking plate may be a universal plate configured to be coupled with multiple forms of mechanical arrangements or specific types of mechanical arrangements. These primary docking plates vary in size and in the type of mounting provisions. Optionally, the docking plate comprises angular brackets to connect additional universal plates or serve as a mounting point for an axle.

Optionally, the central body comprises a top cover supporting the docking plate, located beneath thereof, wherein the top cover comprises fastener provisions such as, pre-tapped or free holes for bolts and nuts or any other fastening interfaces as described earlier for accommodating the docking plates. Generally, any type of coupling is susceptible to hazards and malfunctions; such as, exposed shafts and grab points that present hazards to anybody with loose clothing, hair or laces working in the vicinity of the coupling. To avoid such a dangerous scenario, the central body comprises the top cover, wherein the top cover comprises the fastener provision for accommodating the docking plate. Notably, the fastener provision is designed based on the requirement of the docking plate, whereas the shape and size of the docking plate is dependent upon the type of mechanical arrangement attached to it. The safety benefits of the top cover include protection from other mechanical devices having a lot of moving parts and reduces the probability of a piece of clothing or body part of a nearby operator getting caught during operation; thus, using the top cover will eliminate the possibility of such hazards.

The term “mechanical arrangement” refers to a mechanical system or device to be coupled via the pneumatic coupling system for performing any desired operation. For example, the mechanical arrangement may be any one of a conventional industrial robot, a collaborative robot, a parallel (or delta) robot, a type of mechanical arrangement such as a mechanical chain having rotary, linear joints or a combination of that may require the pneumatic coupling system for operation. Notably, during operation, the mechanical arrangement is configured to change at least a position, orientation or both within a 3-dimensional (3-D) space i.e., the environment during operation and thus requires a pneumatic coupling system capable of accommodating the movement of the mechanical arrangement in the environment without restricting its freedom of movement.

The pneumatic coupling system is configured to support any number of end effectors within the operational payload of the mechanical arrangement. Beneficially, the pneumatic coupling system reduces the required number of pneumatic hoses and sets of wires for power supply and communication required by the mechanical arrangement (for example, the base of the mechanical arrangement) to any attached end effector (for example, till the end of the end effector). Moreover, in certain types of mechanical arrangements, the power supply and communication line may be removed entirely when ported through the tool port of the pneumatic coupling system. Beneficially, such a removal of the need for power and communication lines reduces the payload necessity of the mechanical arrangement, reduces wear and tear of the hoses and the wiring packages, reduces downtime arising due to wear and tear of the hoses and the wiring packages that cause split wiring and leads to loss of power supply or erratic communication signalling or tear in vacuum hose leading to loss of fluid pressure. Moreover, the mechanical arrangement enables reduction in overall complexity of cable management, reduction in number of possible failure points in the system, eases troubleshooting of the wiring and hoses of the connected end effectors.

The pneumatic coupling system further comprises one or more arms, with one of the one or more arms extending from the central body along an arm axis (A). Typically, based on the required operation i.e., the required number of end effectors or mechanical devices to be coupled with the mechanical arrangement via the pneumatic coupling system for performing the operation, the number of one or more arms are determined. Herein, at least one of the one or more arms extends from the central body along the arm axis A and is used to further connect other end effectors for operation. Notably, the number, shape and size of each of the one or more arms may be varied based on the requirement. With change in any one of the parameters of the pneumatic coupling system as described herein, including number, shape and size of the one or more arms, a novel configuration of the pneumatic coupling system is achieved and thus, beneficially, by varying the shape, size or lengths of the one or more arms; the pneumatic coupling system enables the mechanical arrangement to operate in a variety of implementational scenarios.

Optionally, each of the one or more arms comprises a sensor connector for receiving power and communication lines associated with the one or more end effectors. The “sensor connector” refers to a pluggable connector configured to receive the power and communication lines associated with the one or more end effectors. Generally, sensor connectors are configured to connect sensing devices and components such as, but not limited to, proximity sensors, photoelectric sensors, ultrasonic sensors, and current or voltage transducers, to provide a durable and secure connection to the pneumatic coupling system, the connected mechanical arrangement, and the one or more end effectors. Beneficially, the sensor connector comprises coded ends offering various pin layouts for increased versatility and flexibility of operation of the pneumatic coupling system and for easy integration of sensors that are part of the mechanical arrangement and accommodate a variety of applications.

The pneumatic coupling system comprises a second fastening interface provided in the said one of the one or more arms to allow for releasably coupling a docking plate of one of the one or more end effectors thereat. Herein, each of the one or more arms comprises the second fastening interface to enable releasable (or detachable) coupling of the docking plate of the one or more end effectors thereat i.e., each of the one or more arms comprises the docking plate for coupling the one or more end effectors. The one or more end effectors may be at least one of an end of arm tooling or pneumatic tool used in various industries that require the pneumatic fluid (or compressed air) for their application such as gripping, drilling, grinding, deburring, nailing, coat spraying, dispensing, pounding, sanding, screwing, fastening, cleaning and so forth.

In an embodiment, the second fastening interface is provided at a length L along the arm axis (A) from the central body, with the length L varying in a range of 1 millimetre (mm) to 1000 millimetres. Typically, the length of the one or more arms of the pneumatic coupling system is potentially varied to achieve different configurations of the pneumatic coupling system and wherein the second fastening interface is provided at the length L along the arm axis A i.e., at the end of the one or more arms. For example, the length L of the one or more arms may be 0.5 mm, 2 mm, 5 mm, 10 mm, 50 mm, 100 mm, 500 mm and so forth. Notably, the length of each of the one or more arms may be different from each other as per requirement and may not always be equal in length.

In an embodiment, the top face is disposed in a XY plane, defined by a X axis and a Y axis of a first coordinate system with a Z axis perpendicular to the X axis and the Y axis therein, and wherein for each of the one or more arms: an arm plane angle (α) of the corresponding arm axis (A) defined by rotation of the XZ plane about the Z axis of the first coordinate system, varies in a range of 0 degrees to 360 degrees and an arm angle (β) of the corresponding arm axis (A) defined by rotation of a about the Y axis of the first coordinate system, varies in a range of −165 degrees to +165 degrees. The top face is disposed in the XY plane, defined by the X axis and the Y axis of the first coordinate system with the Z axis perpendicularly downward from the XY plane such that the X, Y & Z axis are mutually perpendicular to each other. Herein, the “arm plane angle” refers to the angle associated with the arm plane and defined by the rotation of the XZ plane about the Z axis and generally indicates an orientation of the one or more arms w.r.t to the first coordinate system. Further, the 0 to 360 degrees range of the arm plane indicates a completely unrestricted freedom of rotation of the mechanical arrangement coupled to the pneumatic coupling system, in the said rotational direction. The “arm angle” refers to the angle defined by the rotation of the arm axis A about the Y axis of the first coordinate system and indicates another orientation of the one or more arms w.r.t to the first coordinate system. Furthermore, the −165 to 165 degrees range of the arm angle indicates a partially restricted freedom of movement in lieu of the configurable angle available for the arms of the pneumatic coupling system. Herein, the first coordinate system is associated with the first fastening interface (also referred to as pneumatic coupling system (PCS) frame. The arm plane is defined along the XZ plane of the first coordinate system, wherein the configuration of the one or more arms is achieved by performing at least one of two distinct transformations with respect to the arm plane angle (α) or the arm angle (β). Typically, the arm plane angle (α) transformation is defined by the rotation of the PCS frame about the Z axis along the XY plane and may be varies in the range of 0-360 degrees; and the arm angle (0) transformation is defined by the rotation of the PCS frame about the Y axis along the XZ plane and varies in a range of −165 to +165 degrees. Upon performing the above two transformations, the resultant along the Z-axis defines the arm axis (A) and wherein the end effectors are coupled at the length (L) along the arm axis.

In another embodiment, for each of the one or more arms, the arm axis (A) defines a Z′ axis of a second coordinate system with a X′ axis and a Y′ axis perpendicular to the Z′ axis, Y′ axis is along the arm plane and a X′Y′ plane defining a plane for the second fastening interface therein, and the transformation is done in the following order starting with Z′ axis, followed by Y′ axis and finally the X′ axis wherein for the corresponding one of the one or more end effectors: an end effector plane angle (α′) defined by rotation of a X′Z′ plane about the Z′ axis of the second coordinate system, varies in a range of 0 degrees to 360 degrees, a first end effector angle (β′) defined by rotation of the X′Z′ plane about the Y′ axis of the second coordinate system, varies in a range of −165 degrees to +165 degrees, and a second end effector angle (γ′) defined by rotation of the Y′Z′ plane about the X′ axis of the second coordinate system, varies in a range of −165 degrees to +165 degrees. Typically, for each of the one or more arms, the arm axis (A) defines the Z′ axis of the second coordinate system and wherein the X′Y′ plane of the second coordinate system defines the plane for the second fastening interface. Herein, the second coordinate system associated with second fastening interface of the one or more end effectors, comprises an interface plane defined along the X′Y′ plane. The second fastening interface configured to accommodate the docking plate for the one or more end effectors is located in the X′Y′ plane (i.e., the interface plane). Herein, for each of the one or more arms, the end effector plane angle α′, the first end effector angle β′ and the second end effector angle γ′ is defined by the rotation of the X′Y′ plane about the Z′ axis, the rotation of the X′Z′ plane about the Y′ axis, and the rotation of Y′Z′ plane about the X′ axis of the second coordinate system, respectively; wherein, the range for the end effector plane angle varies in the range of 0 to 360 degrees and the first & second end effector angles vary in the range of −165 degrees to +165 degrees.

In yet another embodiment, the corresponding one of the one or more end effectors, an end effector face angle (δ) defined by rotation of the corresponding one of the one or more end effectors about the Z′ axis of the second coordinate system, varies in a range of 0 degrees to 360 degrees. The end effector face angle refers to the angle made by the face of the one or more end effectors about the Z′ axis of the second coordinate system as defined by the arm axis A of the respective one or more arm. Typically, the 0 to 360 degrees end effector face angle δ range indicates that the one or more end effectors are free to move about the Z′ axis defined by the one or more arms. This is done to provide feasibility to rotate the end effector face based on the final end use of the pneumatic coupling system.

Typically, the pneumatic coupling system is configured to vary at least one configuration parameter of the pneumatic coupling system to achieve a different physical configuration required for the operation of the connected mechanical arrangement and the one or more end effectors. The “configuration parameter” refers to physical configurations of the pneumatic coupling system to be varied during manufacturing as per the requirement. The at least one configuration parameter may be at least one of number of end effectors i.e., the number of arms N, the length of each arm from the central body of the pneumatic coupling system, the arm plane angle (α), the arm angle (β), the end effector angle, the end effector plane angle (α′), the first end effector angle (β′), the second end effector angle (γ′) and the end effector face angle (δ) and the like. Thus, by varying any one of the at least one configuration parameter a different physical configuration of the pneumatic coupling system is achieved. Beneficially, infinite number of possible physical configurations may be formed by varying the at least one configuration parameter allowing the pneumatic coupling system to be implemented in various types of situations and applications that may otherwise require different types of the same or different mechanical devices (or tools) during operation.

In another embodiment, the at least one configuration parameter comprises an arm length, arm plane angle, arm angle, end effector angle, end effector plane angle, end effector face angle. Thus, by varying the at least one configuration parameter associated with each of the mechanical arrangement, the one or more end effectors and the pneumatic coupling system itself, a different physical configuration of the pneumatic coupling system is achieved. Beneficially, depending upon on the type of application, one or more of the at least one configuration parameter may be varied to enable the pneumatic coupling system to operate effectively and efficiently to perform the required operation.

In industrial applications, the pneumatic coupling system enables an operator to utilize two or more different types of mechanical devices (or end effectors) at the same time, without needing to switch the operating device altogether. Beneficially, such an application increases the versatility of the pneumatic coupling system i.e., enables the pneumatic coupling system to be used in various situations, reduces the time taken in switching the devices, and thus improving the overall efficiency of the operation.

In another embodiment, the one or more end effectors coupled with the pneumatic coupling system comprises different tool configurations, wherein the different tool configurations are achieved by dynamically varying configuration parameters of the pneumatic coupling system as described above. The different physical configurations refer to the customized physical configurations related to position and orientation of the one or more end effectors associated with the one or more arms of the pneumatic coupling system with respect to the mechanical arrangement, that may be required in different industrial applications/operations. It will be appreciated that the pneumatic coupling system of the present disclosure can achieve numerous physical configurations to enable the operator using the pneumatic coupling system to perform operation using the end effectors coupled thereto at all various possible locations and orientations and are not limited to the aforementioned physical configurations.

In an example, first of the infinite possible combinations is the 0-degree configuration, wherein the one or more end effectors is mounted in-line with the Z-axis of the tool frame of the mechanical arrangement. In another example, second of the infinite possible combinations is the 180-degree configuration, wherein at least two different end effectors of the one or more end effectors mounted at the distance of L while their tool frame orientation is along the z-axis of the tool frame of the mechanical arrangement. In another example, third of the infinite possible combinations is the 90-degree configuration, wherein at least two different end effectors of the one or more end effectors may be mounted at 45-degree orientation along the ZX or ZY plane of the tool frame of the mechanical arrangement. Thus, in this configuration, the two different end effectors are 90 degrees apart from each other. Similarly, there exists infinite possible orientations for mounting the one or more end effectors to the mechanical arrangement using the pneumatic coupling system.

The pneumatic coupling system comprises a fluid manifold having a fluid inlet port configured to receive a pneumatic fluid. The fluid inlet port is operable to receive the pneumatic fluid to be used in operation with the one or more end effectors as per requirement. The “fluid inlet” refers to a tube, a valve, or any other part through which the pneumatic fluid enters the pneumatic coupling system. Typically, the pneumatic fluid flows in steadily through the fluid inlet port that may be connected to a pneumatic fluid source (or reservoir) for provision to the end effectors or even for direct dispensing applications. Optionally, the fluid inlet port is coupled to fluid source such as a reservoir, a tank or a pump for drawing the pneumatic fluid and ensure a continuous supply of the pneumatic fluid available to the fluid inlet port and thus, to the mechanical arrangement and the one or more end effectors during operation. When the pressure at the fluid inlet port is lower than the reservoir pressure, the reservoir pressure acting on the pneumatic fluid in the reservoir forces the pneumatic fluid into the fluid inlet port. Optionally, the pneumatic fluid is provided via an external pump to ensure a continuous supply of the pneumatic fluid and enable uninterrupted operation.

The “fluid manifold” refers to a pneumatic fluid distribution system or device configured to at least cover the fluid inlet port and serve as a junction, to convert a single channel from the fluid inlet port to multiple outlets based on the requirement. Typically, the fluid manifold is configured to cover at least the fluid inlet and distribute the pneumatic fluid to different parts of the pneumatic coupling system. The fluid inlet manifold also serves as an intersection point for a collection of tubes connected to the fluid inlet to transport the pneumatic fluid to one or more outlets of the pneumatic coupling system. Generally, the fluid manifold ranges from simple supply piping (or chambers) with multiple outlets to multi-chambered flow control units including integral control valves and various interfaces to electronic networks. Notably, beneficially, the fluid manifold is configured to utilize complex pneumatic circuits with interfaces to sophisticated electronic networks and provide a better alternative having fewer connections and a simpler construction having lower associated costs.

In an embodiment the manifold for fluid circuits is a pneumatically closed body that can be manufactured through additive manufacturing (metal & non-metal). This manifold has lower weight-to-strength ratio and a smaller overall size, as compared to manifold manufactured by standard manufacturing techniques. Further, the manifold has a provisioning mechanism for at least a single inlet of air, and provides a mechanism for multiple control valves, wherein each control valve enables controlling the direction, flow, and pressure of air within the pneumatic coupling system and to the end effectors.

In an embodiment the manifold provides support mechanism for the end effectors. Further, the manifold has provision to mount the electrical control board and has spacing for running wires associated with the functioning of the electrical control board. Further, the manifold body can be used for applications using vacuum (Suction), compressed air, and hydraulics.

Optionally, the fluid manifold comprises different circuits and incorporate a number of other components such as, but not limited to, pipes or tubes to transport the pneumatic fluid, fittings (such as tees, elbows, crosses, plugs, and other parts that fit pipes to the inlet manifold), expansion chambers to allow a certain percentage of expansion in the piping line to prevent pressure increase in the pneumatic coupling system, extend seal life and prevent potential leakage from connected valves, flexible connectors or instruments (such as pressure gauges, switches, and other devices used to perform various system functions involving measurement). Notably, matching the performance specifications for the fluid manifold to the needs of the application is important for proper selection and includes matching of at least a maximum pressure i.e., amount of force exerted on the pneumatic coupling system by the pneumatic fluid, maximum flow i.e., the maximum rate of flow of the pneumatic fluid through the pneumatic coupling system and temperature range i.e., the full required range of safe ambient or fluid operating temperatures.

The pneumatic coupling system comprises a dispensing port associated with the at least one of the one or more arms. The dispensing port is connected to each of the one or more arms configured to be coupled with the one or more end effectors for operation. Herein, the pneumatic coupling system controls the flow rate and pressure of the pneumatic fluid dispensed via the dispensing port. The pressure and flow rate of the pneumatic fluid may be controlled by the pneumatic coupling system depending on the application. For example, the fluid pressure and flow rate for a coolant dispersion using compressed air will differ from a polishing application with lacquer coating. Thus, beneficially, the one or more end effectors and the dispensing port may have independent fluid pressure and flow rates due to isolation valves provided between the one or more end effectors and the dispensing port.

In an embodiment, the dispensing port is provided in each of the at least one of the one or more arms, disposed between the central body and the second fastening interface therein. Typically, the dispensing port is provided in each of the at least one of the one or more arms and is disposed between the central body and the second fastening interface. The dispensing port may be located along the length of the Arm axis (A), and/or at a distance D′ from the first fastening interface (i.e., the centre of the first fastening interface to the dispensing port). Beneficially, the dispensing port comprises a completely unrestricted freedom of movement and wherein the axis of the dispensing port is defined by the X axis of the first coordinate system associated with the pneumatics coupling system frame. Herein, the dispensing port forms a dispensing port angle (ε′) with respect to the X axis and may vary between 0 degrees to 360 degrees along the arm axis or Z axis. However, in certain configurations, wherein the arm length (L) is lesser than 40 mm, the dispensing port may not be disposed along the arm axis. In such configurations, the dispensing port is disposed along the Z axis of the first coordinate system at the distance D′ from the centre of first fastening interface or the first coordinate system. Hence, in such configurations the dispensing port angle ε′ are not applicable. For example, if the arm length is 30 mm, the dispensing port angle is not defined and hence located at the distance D′ (for example, 15 mm) from the centre of the first fastening interface and oriented along the Z axis of the first coordinate system.

In an embodiment, the pneumatic coupling system further comprises a liquid fluid port configured to receive a liquid fluid, and wherein the fluid circuit is configured to supply the liquid fluid to the dispensing port of the corresponding arm to be dispensed thereby. Herein, the liquid fluid port may be disposed in fluid communication with the fluid manifold and supply the received liquid fluid therefrom to the dispending port(s). In one or more examples, the liquid fluid may include, but not limited to, cool or hot water, oil, coolant or any other required fluid as per the application of the end effector. Optionally, the liquid fluid port is configured to receive the pneumatic fluid, wherein the fluid circuit is configured to supply the pneumatic fluid to the dispensing port of the corresponding arm to be dispenser thereby.

The dispensing port may be used either directly or indirectly i.e., connected to a reservoir of fluid for dispensing applications. Beneficially, the one or more end effectors does not require long hoses and tubes to perform its application; since the pneumatic fluid is provided directly through the fluid ports which run through the pneumatic coupling system and the secondary docking plate, does not require long wiring packages to run through the entire body length of the end effector and are connected to the pneumatic coupling system via a single wire run from the pneumatic coupling system to the controller of the mechanical arrangement. Moreover, based on the application of the one or more end effectors, the associated docking plate can be varied to accommodate for all the required operating states.

Notably, the pneumatic coupling system is not limited to gripping applications, but to all applications using pneumatics such as grinding, drilling, sanding and so on. This provides a huge variety of combinations between different types of mechanical arrangements. The pneumatic coupling system comprises coupled applications for the one or more end effectors in the form of air dispensers or liquid dispensers using the dispensing port. Beneficially, such an application of the one or more end effectors with the associated dispensing port reduces cycle time of applications for the mechanical arrangement by more than half; since, both the applications of the one or more end effectors and the dispensing port occur simultaneously. Moreover, it does not require significant pathing changes of the fluid circuit for the mechanical arrangement or require tool changes either.

The pneumatic coupling system comprises a fluid circuit for each of the one or more arms, disposed in fluid communication with the fluid manifold to receive the pneumatic fluid therefrom. The “fluid circuit” refers to the collection of tubes or pipes configured to carry and transport the pneumatic fluid from the fluid inlet. Typically, the fluid circuit is connected to the fluid manifold and wherein the number of pipes in the fluid circuit is dependent upon the number of pneumatic end effectors required or the number of the one or more arms of the pneumatic coupling system. Generally, each arm of the one or more arms of the pneumatic coupling system comprises a separate collection of tubes or pipes for transporting the pneumatic fluid from the fluid manifold.

The fluid circuit comprises a first fluid outlet line for supplying the pneumatic fluid to the one or more end effectors. The first outlet line in fluid communication with the one or more end effectors is configured to provide the pneumatic fluid to the coupled end effectors or mechanical devices (or tools) based on the requirement of the application. The fluid circuit further comprises a second fluid outlet line for supplying the pneumatic fluid to the dispensing port. Typically, the fluid circuit comprises the first and second fluid outlet lines configured to provide the pneumatic fluid to the one or more end effectors or to the dispensing port, respectively. Herein, each of the first fluid outlet line and the second fluid outlet line comprises multiple outlet lines therein configured to provide the supplied pneumatic fluid in multiple directions. In an exemplary scenario, the first fluid outline line further comprises two separate outlet lines for supply bi-directional pneumatic fluid to the coupled end effectors. It will be appreciated that the number of outlet lines in the first or second fluid outline may vary based on the implementation without limiting the scope of the disclosure. Generally, the pneumatic fluid is compressed air and dispensed at a required operating state controlled by the pneumatic coupling system, wherein the pneumatic fluid is provided to the one or more end effectors and the dispensing port upon passing through the fluid manifold and the one or more control valves of the fluid circuit. The second fluid line is configured to provide the pneumatic fluid to the dispensing port for direct or indirect dispensing applications. The applications include coat curing, clearing drilling chips, cleaning dust from sanding and so forth. Examples of indirect use of the dispensing port includes dispensing applications like gluing, bonding, sealing, coating and so forth. Optionally, a fluid reservoir may be coupled with the dispensing port for further dispensing purposes. The fluid reservoir may be locally mounted with the pneumatic coupling system or mounted with the mechanical arrangement or positioned separately from the pneumatic coupling system. Additionally, the end effectors such as, dispensing end effectors may be mounted on the dispensing port for further dispensing applications.

In an embodiment, the fluid circuit further comprises one or more isolation valves to segregate the supply of the pneumatic fluid to the first fluid outlet line and the second fluid outlet line. Generally, different types of mechanical arrangements and end effectors require a different type of pneumatic fluid, or a different operating state (such as pressure, temperature etc.) of the pneumatic fluid and thus generates a requirement for separately transporting the pneumatic fluid at the required operating state. Thus, to fulfil the aforementioned requirement, the fluid circuit comprises the one or more isolation valves configured to segregate the supply of the pneumatic fluid to the first fluid outlet line and the second fluid outlet line and enable separate provision of the pneumatic fluid via the first and second fluid outlet line. Typically, the pneumatic fluid travels from the fluid inlet port to the fluid manifold and then separately distributed either simply via the first or second outlet lines of the connected fluid circuit, or via the one or more isolation valves in the fluid circuit. Beneficially, the one or more isolation valves enables the pneumatic coupling system to provide the pneumatic fluid separately to the connected mechanical arrangement or the one or more end effectors.

In another embodiment, the fluid circuit further comprises of one or more control valves associated with each of the first fluid outlet line and the second fluid outlet line to regulate the supply of the pneumatic fluid therein; and one or more isolation valves to segregate the supply of the pneumatic fluid to the first fluid outlet line and the second fluid outlet line. Herein, the fluid circuit comprises the one or more control valves associate with each of the first and second outlet line to regulates the supply of the pneumatic fluid therein. Typically, the one or more control valves regulate at least one of pressure, flow rate or direction. The term “operating state” refers to the physical state of the pneumatic fluid being transported through the one or more control valves. For example, the operating state may refer to the temperature, pressure, volume, density, entropy, enthalpy, or internal energy of the pneumatic fluid. Upon being isolated, the pneumatic fluid is made to pass through the one or more control valves to enable provision of the pneumatic fluid at the required operating state. The control valve (or the control valve) refers to a valve used to control the pneumatic fluid flow by varying the size of the flow passage (of the one or more pipes in the fluid circuit).

Beneficially, the one or more control valves enable the pneumatic coupling system to directly control flow rate of the pneumatic fluid and the consequential control of the operating state such as pressure, temperature, and fluid level of the pneumatic fluid. Generally, the pressure is created by a combination of the flow generated via the fluid inlet port and the resistance to flow created by friction and restrictions within the pneumatic coupling system. As the pneumatic fluid flows into the pneumatic coupling system, energy is transmitted to the pneumatic fluid. When the pneumatic fluid flow encounters resistance (resistance to flow is the result of a restriction or obstruction in the flow path), the energy is converted into the resulting pressure. The restriction is normally accomplished by the pneumatic coupling system, however there may also be restrictions created by the piping, fittings, or components within the pneumatic coupling system. Thus, the load (or pressure) imposed on the pneumatic coupling system is beneficially controlled by the action of the one or more regulating valves. Optionally, the fluid circuit comprises precision nozzles for generating a precisely controlled flow for high precision applications and comprises capability to adjust for viscosity change or for volume change of the pneumatic fluid.

It may be appreciated that different fluid outlet forms of the pneumatic fluid may be achieved by using different components including, but not limited to, shape and types of attached nozzles. In an example, the one or more end effectors comprises at least one gripper coupled to the dispensing port with a flat nozzle. In another example, at least one driller coupled to the dispensing port with a round nozzle. In another example, at least one grinder coupled to the at least one air dispenser with a wide nozzle. In another example, at least one sander coupled to the dispensing port with a special nozzle. In another example, at least one gripper coupled to the at least one fluid liquid dispenser port with an elongated nozzle. In another example, at least one polisher coupled to the dispensing port with a coating nozzle.

In another embodiment, the dispensing port is provided in each of the one or more arms, disposed adjacent to the second fastening interface therein. Generally, the dispensing port may be located along the length of the Arm axis (A), and or at a distance D′ from the first fastening interface and thus is located proximal to the second fastening interface configured for accommodating the docking plate of the one or more end effectors. For example, for an arm length of 100 mm, the dispensing port may be provided at 75 mm from the origin of the arm.

In an embodiment, the dispensing port comprises a coupling mount for mechanically coupling with at least one fluid outlet for controlling the operating states of the pneumatic fluid. Herein, the dispensing port is provided with a coupling mount that may be used to connect to a wide variety of fluid outlet forms configured for different types of applications. Notably, the at least one fluid outlet is also configured to control the operating states of the pneumatic fluid. Beneficially, the coupling mount on the dispensing port enables the pneumatic coupling system to mechanically couple with the at least one fluid outlet to change the spread, pressure or concentration, stream flow of the pneumatic fluid output from the dispensing port. In an example, the at least one fluid outlet may be a pointed outlet configured to be inserted into drilled holes to flush out drilling chips with high pinpoint pressure. In another example, the at least one fluid outlet may be a flat thin outlet to increase the spread of fluid for coat curing with precise pathing. In another example, the at least one fluid outlet is a round wide outlet used to blow of dust from the surface due to sanding with high volume. Beneficially, the coupling mount is designed to be able to accept a wide variety of known nozzle sizes, shapes, materials, and types and enables the pneumatic coupling system to expand its applications based on the need for the coupled end effector and generates possibility of customized designs adaptable based on the varying needs of the one or more end effectors if the application parameters, of the part being worked on, changes.

In an embodiment, the pneumatic coupling system comprises a controller and a communication line disposing the controller in signal communication with the mechanical arrangement and one or more end effectors. Typically, the pneumatic coupling system acts as a coupling device between the mechanical arrangement and the one or more end effectors while also controlling their operation via the controller. The controller may be an Electronics Circuit Board (ECB) for enabling operation of the pneumatic coupling system along with the one or more end effectors and regulating the pneumatic fluid depending upon the application intended for the pneumatic coupling system. The controller is further configured to control and/or direct the operation (or action) of the mechanical arrangement in addition to the one or more end effectors coupled thereat. In an example, the controller may be a transceiver configured to both transmit and receive the control signals for controlling operations of the coupled mechanical arrangement and/or the one or more end-effectors. Herein, the controller receives (or transmits) control signals indicative of operation of the mechanical arrangement and/or the one or more end effectors via the communication line, and the controller is configured to regulate the supply of the pneumatic fluid to each of the first fluid outlet line and the second fluid outlet line based on the control signals received thereby, and wherein the controller transmits control signals to the mechanical arrangement indicative of one or more relevant information needed for the specific application such as current position, current orientation of the one or more end effectors, fluid levels and the like. Typically, the control signal is configured to indicate the mechanical arrangement of the current position, orientation of the coupled one or more end effectors and other relevant information such as the fluid levels, positioning and the like, based on the application. Beneficially, the controller enables the pneumatic coupling system to separately control the isolation and control valves of the fluid circuit to effectively regulate the pneumatic fluid for operation. For example, one of the one or more end effectors requires an operating pressure (or state) of 50 bar of the pneumatic fluid, whereas another one of the one or more end effectors requires an operating pressure of 100 bar. Herein, the controller unit is configured to control the one or more control valves to provide the required operating pressure of the pneumatic fluid to the one or more end effectors i.e., the first operating pressure of 50 bar and the second operating pressure of 100 bar to the respective end effector.

Optionally, the controller comprises an electronic interface for providing the electrical circuitry connecting to the one or more isolation valves or the one or more control valves for regulating the supply of the pneumatic fluid. The controller may be included as part or a member of, potentially being positioned within the housing of, the pneumatic coupling system. The controller may be able to detect if any one of the mechanical arrangement or the one or more end effectors is mounted or not.

Such a detection is enabled by one or more sensors connected to the electronic interface and located on the interface, wherein the one or more sensors are activated respectively by mounting of either the mechanical arrangement or the one or more end effectors. The controller controls the actuation and/or de-actuation of the dispensing port connected to the different mechanical devices depending on which the end effector is mounted on the pneumatic coupling system. This may allow the controller unit to control the setting of the operating states of the one or more control valves and eases the use of the coupled mechanical devices. The interface may be connected to the isolation valve or the control valve and may have an input being able to receive an actuation signal and a de-actuation signal from the mechanical arrangement and which is able to transmit the actuation signal and the de-actuation signal to the controller. In an exemplary implementation, when a mechanical arrangement is connected to the controller and when a first or a second end effector is mounted on the pneumatic coupling system, the input may be received as an actuation signal from the mechanical arrangement and transmitted to the controller, upon which the controller is configured to provide the actuation signal to the connected end effector. For example, a gripping actuation of a pneumatically actuated gripper of a first end effector, the gripping actuation of the suction-actuated gripper of the second end effector, or the dispensing actuation of the dispensing actuator of the third end effector upon receiving the actuation signal. Beneficially, the usage of the mechanical arrangement or the one or more end effectors may be further eased as the only signal required to operate the coupled end effectors may be an actuation signal or a de-actuation signal independent on the type of mechanical device, which is mounted, and as such a separate control for each mechanical device may not be required.

In another embodiment, the controller comprises a common socket for receiving the power and communication lines to the mechanical arrangement and the one or more end effectors via the pneumatic coupling system. The common socket is provided either on or in near vicinity of the electronic interface and is configured to receive the power and communication lines for the pneumatic coupling system, wherein the pneumatic coupling system may further distribute the power to the connected mechanical arrangement, or the one or more end effectors based on the requirement. Currently, for every mechanical device (or end effector) attached to the mechanical arrangement; at least one separate compressed air hose, at least one separate electrical power line, and communication line is required from the mechanical arrangement to the end of the one or more end effectors. Thus, at each instance, extra end effectors are required and consequently another package of all the same hoses and wires is applied and becomes increasingly difficult and cumbersome with an increase in the number of end effectors. Beneficially, the inclusion of the common socket simplifies the construction and reduces the associated manufacturing complexity of the pneumatic coupling system by eliminating the need for separate power and communication lines required for each of the mechanical arrangement and the one or more end effectors that makes the pneumatic coupling system less cumbersome and tidy in appearance.

In an embodiment, each of the one or more arms further comprises an exhaust port configured to discharge the pneumatic fluid. In another embodiment, the exhaust port further comprises a pneumatic silencer for reducing noise while discharging the pneumatic fluid via the exhaust port. The pneumatic silencer is configured to transport the pressurized pneumatic fluid safely and quietly to the at least one exhaust port or into atmosphere. Generally, the pneumatic mufflers are installed on air valves, cylinders, manifolds, and fittings and herein the pneumatic coupling system, the pneumatic silencers are placed on each of the arm and in near vicinity of the dispensing port. Beneficially, the pneumatic silencer enables the pneumatic coupling system to remove the noise during operation i.e., during exhaust of the pneumatic fluid that is detrimental to the surrounding environment and potentially harmful to workers.

While the disclosed subject matter has been described in conjunction with several embodiments, it is evident that many alternatives, modifications and variations would be or are apparent to those of ordinary skill in the applicable arts. Accordingly, applicant intends to embrace all such alternatives, modifications, equivalents, and variations that are within the spirit and scope of the disclosed subject matter described herein.

### DETAILED DESCRIPTION OF DRAWINGS

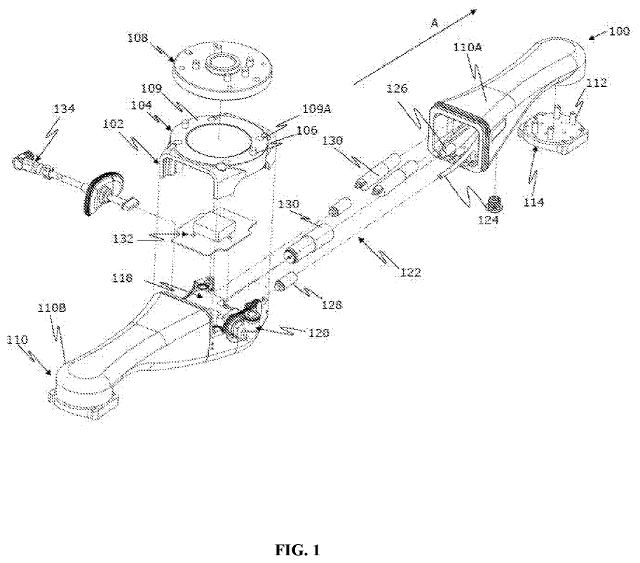

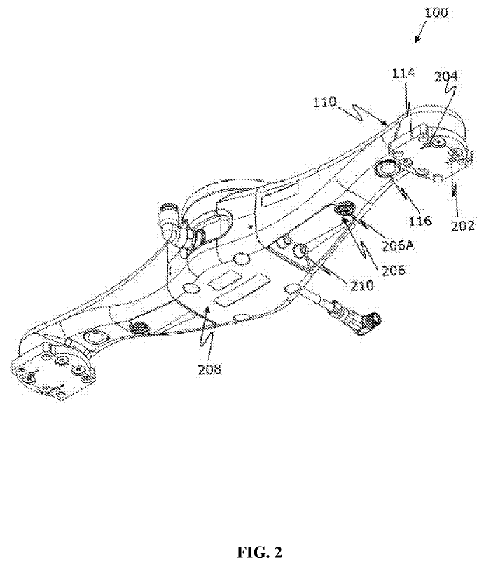

Referring to FIG. 1, illustrated is an exploded perspective view of a pneumatic coupling system 100 for coupling a mechanical arrangement (not shown) to one or more end effectors (not shown), in accordance with an embodiment of the present disclosure. As shown, the pneumatic coupling system 100 comprises a central body 102 providing a top face 104 for coupling a mechanical arrangement to one or more end effectors of the pneumatic coupling system 100. The pneumatic coupling system 100 comprises a first fastening interface 106 provided in the top face 104 of the central body 102 to allow for releasably coupling a docking plate 108 of the mechanical arrangement thereat. Further shown, a top cover 109 placed below the docking plate 108 of the mechanical arrangement thereat, wherein the top cover 109 comprises fastening provisions 109A for accommodating the docking plate 108. For example, the fastening provisions 109A may be pre-tapped holes for accommodating the docking plate 108. Further, the pneumatic coupling system 100 comprises one or more arms 110, with one 110A of the one or more arms extending from the central body 102 along an arm axis A, a second fastening interface 112 provided in the said one of the one or more arms 110A to allow for releasably coupling a docking plate 108 of one of the one or more end effectors thereat. The pneumatic coupling system 100 further comprises a dispensing port 116 (shown in FIG. 2) associated with the at least one of the one or more arms 110A, a fluid manifold 118 having a fluid inlet port 120 configured to receive a pneumatic fluid and a fluid circuit 122 for each of the one or more arms 110, disposed in fluid communication with the fluid manifold 118 to receive the pneumatic fluid therefrom, the fluid circuit 122 comprising a first fluid outlet line 124 for supplying the pneumatic fluid to the one or more end effectors and a second fluid outlet line 126 for supplying the pneumatic fluid to the dispensing port 116. Furthermore, the fluid circuit 122 comprises one or more isolation valves 128 to segregate the supply of the pneumatic fluid to the first fluid outlet line 124 and the second fluid outlet line 126. Optionally, the fluid circuit 122 further comprises one or more control valves 130 associated with each of the first fluid outlet line 124 and the second fluid outlet line 126 to regulate the supply of the pneumatic fluid therein and one or more isolation valves 128 to allow for varying the supply of the pneumatic fluid to the first fluid outlet line 124 and the second fluid outlet line 126. Furthermore, the pneumatic coupling system 100 comprises a controller 132 and a communication line 134 disposing the controller 132 in signal communication with the mechanical arrangement, wherein the controller 132 receives and transmits control signals indicative of operation of the mechanical arrangement via the communication line 134.

Referring to FIG. 2, illustrated is a bottom perspective view of the pneumatic coupling system 100 for coupling a mechanical arrangement to one or more end effectors, in accordance with an embodiment of the present disclosure. As shown, each of the one or more arms 110 comprises the docking plate 108. Notably, each of the docking plate 108 (shown in FIG. 1) of the mechanical arrangement thereat and the docking plate 108 of the one or more end effectors comprises the first fastening interface 106 and the second fastening interface 112 to detachably couple the mechanical arrangement and the one or more end effectors, respectively. Further, the one of the one or more arms 110 comprises the dispensing port 116 for dispersing a pneumatic fluid and wherein the docking plate 108 comprises a first dispensing port 202 and a second dispensing port 204 for supplying the bidirectional pneumatic fluid to the one or more end effectors. Furthermore, each of the one or more arms 110 comprises an exhaust port 206 for dispensing a pneumatic fluid and wherein the exhaust port 206 comprises a pneumatic silencer 206A for reducing noise while discharging the pneumatic fluid via the exhaust port 206. Furthermore, as shown, the central body 102 of the pneumatic coupling system 100 comprises the bottom cover 208 to enclose components inside the central body 102. Furthermore, each of the one or more arms 110 comprises a sensor connector 210 for receiving power and communication lines 134 to the one or more end effectors.

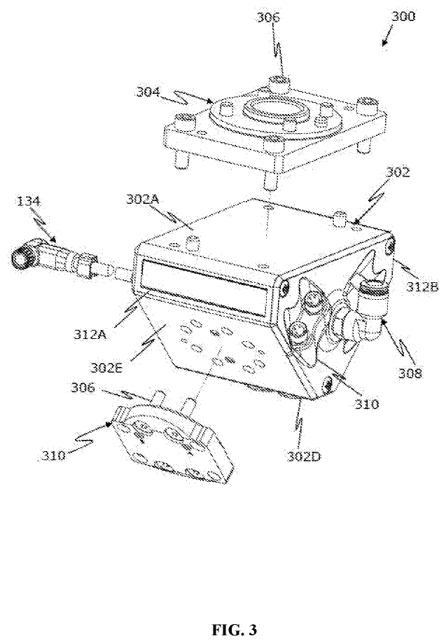

Referring to FIG. 3, illustrated is an exploded perspective view of another pneumatic coupling system 300 for coupling a mechanical arrangement to one or more end effectors, in accordance with another embodiment of the present disclosure. As shown, another pneumatic coupling system 300 is an alternative physical configuration of the pneumatic coupling system 100; specifically, the pneumatic coupling system 300 has a 90-degree configuration. As shown, the pneumatic coupling system 300 comprises a central body 302 having an inverted pyramidal shape and having four faces and two sides, namely a first face 302A (or top face), a second face 302B (a back face), a third face 302C (or front face), a fourth face 302D (or a bottom face), a first side 302E (or front side), a second side 302F (or back side); wherein two of the four faces i.e., the second face 302B and the third face 302C are inclined at an angle of 90 degree with respect to the first face 302A. Further, the central body 302 comprises a docking plate 304 located on the first face 302A configured for releasably coupling a mechanical arrangement thereat, wherein the docking plate 304 comprises the first fastening interface 306 (similar to the first fastening interface 106 of FIG. 1) for releasably coupling therewith. Furthermore, the pneumatic coupling system 300 comprises a fluid inlet port 308 operable to receive a pneumatic fluid and located on the third face 302C. Further, the pneumatic coupling system 300 comprises a docking plate 310 located on the first side 302E, wherein the docking plate 310 comprises the second fastening interface 306 for releasably coupling therewith. Furthermore, the third face 302C of the central body 302 comprises one or more sensor connectors 310 for receiving power and communication lines 134. Furthermore, the pneumatic coupling system 300 comprises a fluid circuit 122 (not shown) in fluid communication with the fluid inlet 308. Furthermore, to completely enclose the central body 302 i.e., even the region between each of the first face 302A, the second face 302B and third face 302C; the central body 302 comprises a first side cover 312A for the first side 302E and a second side cover 312B (generally shown) for the second side 302F. It will be appreciated that the side covers 312A and 312B are provided as per the implementation and design requirements of the pneumatic coupling system 300, wherein 312A is a continuous body from 302A to 302E and 312B is a continuous body from 302A to 302F.

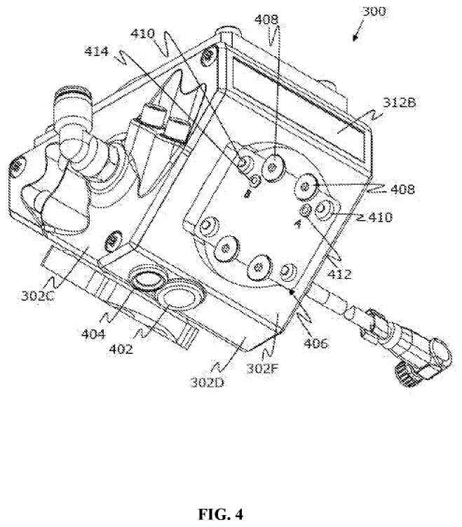

Referring to FIG. 4, illustrated is a bottom perspective view of the pneumatic coupling system 300 for operatively coupling two or more mechanical devices, in accordance with an embodiment of the present disclosure. As shown, one of the two sides i.e., the second side 302F and two of the four faces i.e., the third and fourth face of the of central body 302 are depicted to illustrate all faces and sides of the pneumatic coupling system 300. Herein, the central body 302 comprises the fourth face 302D (also the bottom face), wherein the fourth face 302D comprises a dispensing port 402 (similar to the dispensing port 116 of FIG. 2) and an exhaust port 404 (similar to the exhaust port 206 of FIG. 2). Moreover, the central body 302, on the second side 302F, comprises the docking plate 406 (similar to the docking plate 310 located on the first side 302E) for coupling with the one or more end effectors Herein, the docking plate 406 comprises a fastening interface 408 (similar to the second fastening interface 306 located on the first side 302E) to detachably couple with the one or more end effectors (not shown), wherein the fastening interface 408 comprises a fastener 410 for the docking plate 406 to the side face 302F and a fastening interface 408 for docking the one or more end effectors. Moreover, the docking plate 406 comprises a first dispensing port 412 and a second dispensing port 414 for supplying the pneumatic fluid to the one or more end effectors.

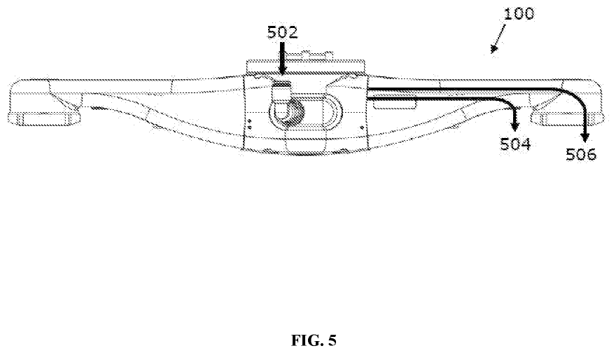

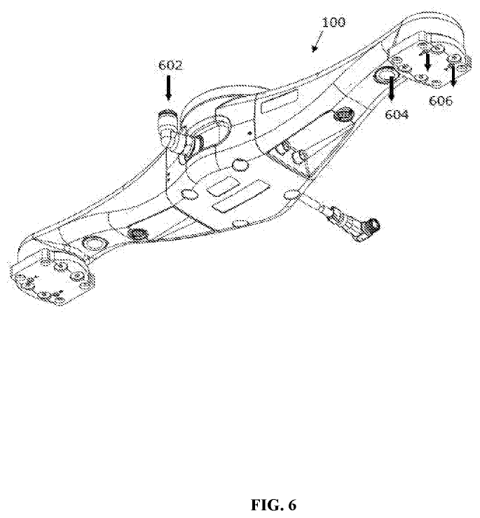

Referring to FIGS. 5 and 6, illustrated are side view and bottom perspective view of the pneumatic coupling system 100, in accordance with an embodiment of the present disclosure. The side view is illustrated to depict the fluid flow of the pneumatic fluid inside the pneumatic coupling system 100 i.e., from the fluid inlet port 120 passing via the fluid circuit 122 (not shown) to the dispensing port 116, the first dispensing port 202 and the second dispensing port 204 located on each of the one or more arms 110 and the second docking plate 108, respectively. As may be understood, the pneumatic fluid enters from the fluid inlet port 120 (as depicted by the first arrows 502, 602) and then distributed separately via the fluid manifold 118 and the one or more isolation valves 128 to the dispensing port 116 located on one of the one or more arms 110 (as depicted by the second arrows 504, 604) and to the first and second dispensing ports 202 and 204 located on the docking plate 108 (as depicted by the third arrows 506, 606).

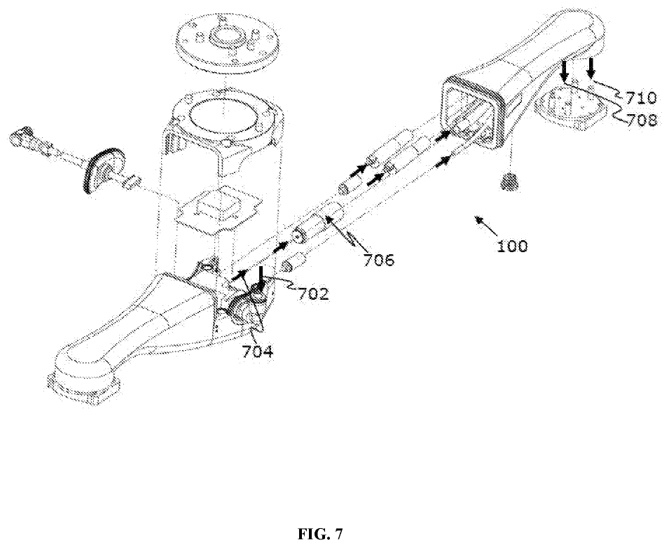

Referring to FIG. 7, illustrated is an exploded perspective view of the pneumatic coupling system 100 depicting components of fluid circuit for flow of the pneumatic fluid therein, in accordance with an embodiment of the present disclosure. The view depicts the fluid flow of the pneumatic fluid inside the pneumatic coupling system 100 i.e., from the fluid inlet port 120 passing via the fluid circuit 122 to the dispensing port 116, the second dispensing port 204 and the first dispensing port 202 located on one of the one or more arms 110A and the docking plate 108, respectively. As shown, the pneumatic fluid enters the pneumatic coupling system 100 via the fluid inlet 120 (as depicted by a first arrow 702). Furthermore, upon entering the fluid inlet 120, the pneumatic fluid travels through the fluid inlet manifold 118 (as depicted by a second arrow 704) for further distribution via the fluid circuit 122. Further shown, the pneumatic fluid travels via the fluid circuit 122 and passes through (as shown by a set of third arrow 706) the one or more isolation valves 128, the one or more control valves 130 for separately transporting the controlled pneumatic fluid to the dispensing port 116 located on the one or more arms 110 and dispersed therefrom (as depicted by the fourth arrow 708), and the first and second dispensing ports 202 and 204 located on the docking plate 114 and dispersed therefrom (as depicted by the fifth arrow 710).

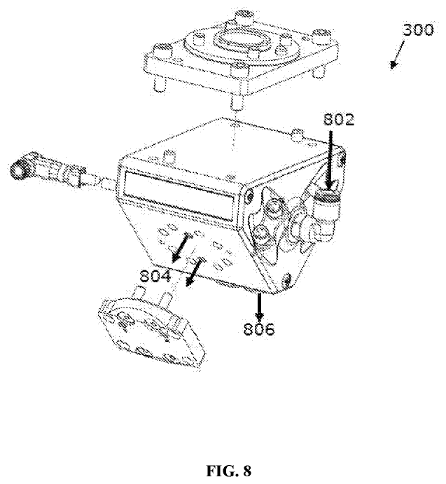

Referring to FIG. 8, illustrated is an exploded perspective view of the pneumatic coupling system 300 depicting components of fluid circuit for flow of the pneumatic fluid therein, in accordance with an embodiment of the present disclosure. The view is illustrated to depict the fluid flow of the pneumatic fluid inside the pneumatic coupling 300 i.e., from the fluid inlet port 308 and travels via the fluid circuit 122 to the dispensing port 402 located on the fourth face 302D and the first and second dispensing ports 412 and 414 located on the docking plate 406. As shown, the pneumatic fluid enters the fluid inlet port 308 (as depicted by a first arrow 802) and upon passing through the inlet manifold 118 (not shown); the pneumatic fluid is distributed to the dispensing ports 402, and the first and second dispensing ports 412 and 414 and the docking plate 406 (as depicted by a second arrow 804 and a third arrow 806, respectively).

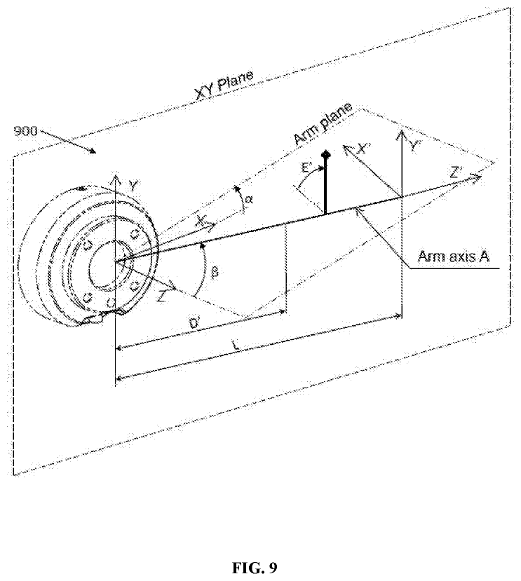

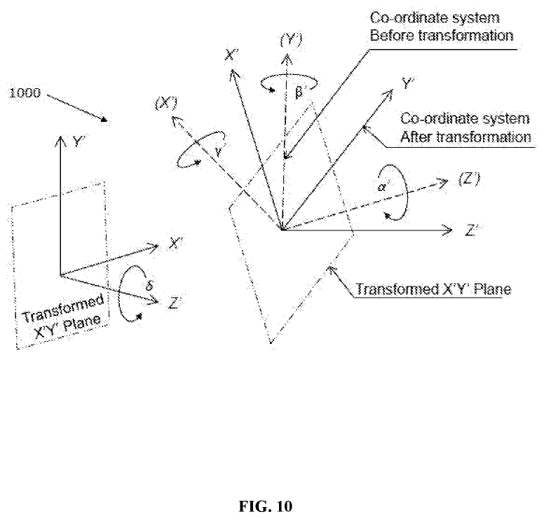

Referring to FIGS. 9 and 10, illustrated are diagrammatic representations of a first coordinate system 900 and a second coordinate system 1000 respectively, as associated with the pneumatic coupling system 100, 300 for coupling the mechanical arrangement and the one or more end effectors, in accordance with an embodiment of the present disclosure. Herein, as may be understood, the top face 104 & 302A is disposed in a XY plane, defined by a X axis and a Y axis of the first coordinate system with a Z axis perpendicular to the X axis and the Y axis therein, and wherein for each of the one or more arms, an arm plane angle α of the corresponding arm axis A defined by rotation of the XY plane about the Z axis of the first coordinate system 900, varies in a range of 0 degrees to 360 degrees, and an arm angle β of the corresponding arm axis A defined by rotation of a XZ plane about the Y axis of the first coordinate system 900, varies in a range of −165 degrees to +165 degrees. Further, in each of the at least one of the one or more arms, the dispensing port is disposed between the central body and the second fastening interface therein. Typically, the dispensing port is disposed along the length L of the arm axis A and/or at a distance D′ from the first fastening interface along the arm axis A of the first coordinate system 900. When disposed along the arm axis A, at the disposed location at the distance D′ from the first fastening interface, the dispensing port axis defines the dispensing port angle ε′ that varies in a range of 0 degrees to 360 degrees. Moreover, the dispensing port angle ε′ is defined by the X′ axis of the second coordinate system 1000 and varies in the range of 0 degrees to 360 degrees around the arm axis A. Referring to FIG. 10, further shown, for each of the one or more arms, the arm axis A defines a Z′ axis of a second coordinate system 1000 with a X′ axis and a Y′ axis perpendicular to the Z′ axis, and a X′Y′ plane defining a plane for the second fastening interface therein, and wherein for the corresponding one of the one or more end effectors and end effector plane angle α′ defined by rotation of a X′Y′ plane about the Z′ axis of the second coordinate system 1000, varies in a range of −0 degrees to +360 degrees, a first end effector angle β′ defined by rotation of the X′Z′ plane about the Y′ axis of the second coordinate system 1000, varies in a range of −165 degrees to +165 degrees, and a second end effector angle γ′ defined by rotation of the Y′Z′ plane about the X′ axis of the second coordinate system 1000, varies in a range of −165 degrees to +165 degrees. Moreover, for the corresponding one of the one or more end effectors, an end effector face angle δ defined by rotation of the corresponding one of the one or more end effectors about the Z′ axis of the second coordinate system 1000, varies in a range of 0 degrees to 360 degrees.

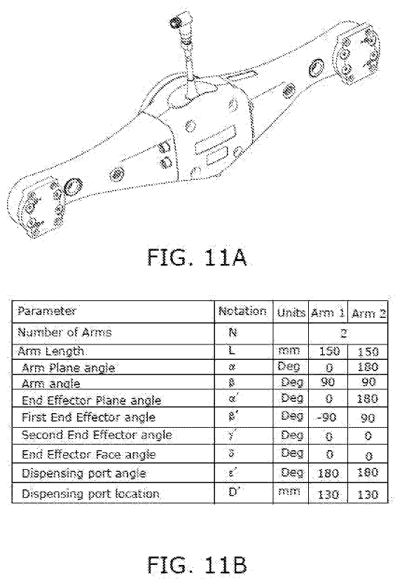

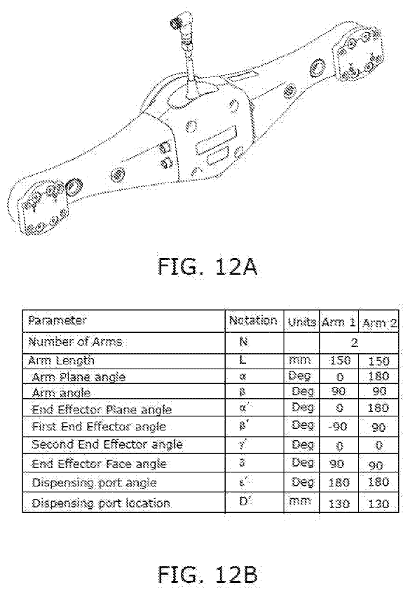

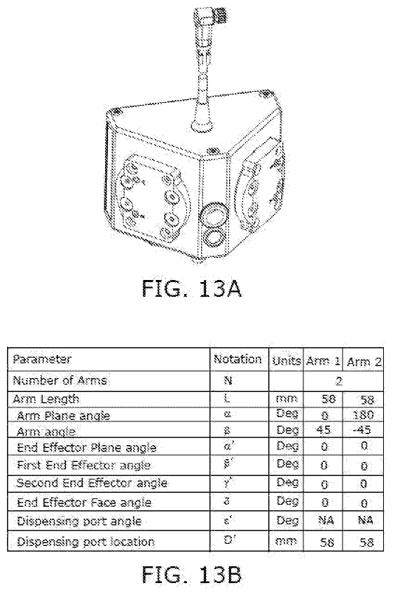

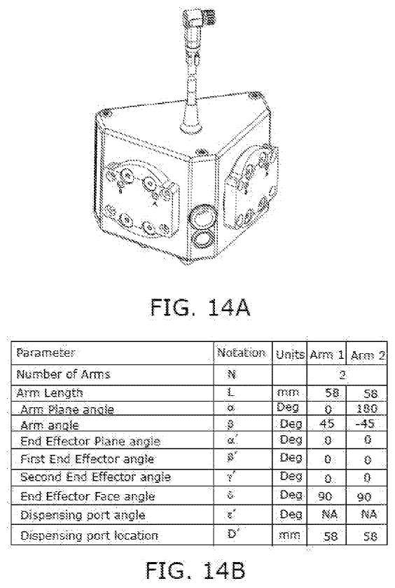

Referring to FIGS. 11A-14B, illustrated are various physical configurations of different pneumatic coupling systems and corresponding tabular representations detailing configuration parameters of the respective pneumatic coupling systems, in accordance with various embodiments of the present disclosure. Herein, different configurations are obtained by varying at least one configuration parameter of the pneumatic coupling system (such as the pneumatic coupling system 100, 300) as required for the operation. Herein, the configuration parameter includes at least one of number of arms N, a length L of the one or more arms 110, an arm plane angle α, an arm angle β, an end effector plane angle α′, a first end effector angle ε′, a second end effector angle γ′, an end effector face angle δ, dispensing port location D′ and a dispensing port angle ε′. Beneficially, by changing any one of the configuration parameters a new configuration of the pneumatic coupling system is achieved that may be used to perform a variety of operations present in different situations and locations effectively and efficiently. As shown, each of the table provides the values for the number of arms N, the length L of the one or more arms 110, the arm plane angle α, the arm angle β, the end effector plane angle α′, the first end effector angle β′, the second end effector angle γ′ and the end effector face angle δ, dispensing port location D′ and a dispensing port angle ε′ for the respective configuration, like Table of FIG. 11B for configuration of FIG. 11A, Table of FIG. 12B for configuration of FIG. 12A, and so on.

As an example, referring to FIG. 11A illustrated is a “180-degree configuration” of the pneumatic coupling system, in accordance with an embodiment of the present disclosure. As provided in corresponding table of FIG. 11B, the pneumatic coupling system comprises two numbers of arms (a first arm and a second arm), i.e., A=2. Herein, each arm has an equal length, L=200 mm. Further, the arm plane angle α is 0 degree and 180 degrees for the first arm and the second arm, respectively (thus forming the 180-degree configuration). Further, an arm angle β for each of the first arm and the second arm is 90 degrees in opposite directions, an end effector plane angle α′ is 0 degree for both arms, a first end effector angle β′ is similar to the arm angle β i.e., 90 degrees in opposite directions for each arm. Further, the second end effector angle γ′ is 90 degrees for each arm. Also, the end effector face angle S (representative of docking plate orientation in the pneumatic coupling system) is 0 degrees for each arm. The dispensing port location D′ is 150 mm and a dispensing port angle ε′ is 180-degree.

Other examples as depicted in FIGS. 12A-14B may be understood based on the provided details in the drawings and have not been described herein for the brevity of the present disclosure.

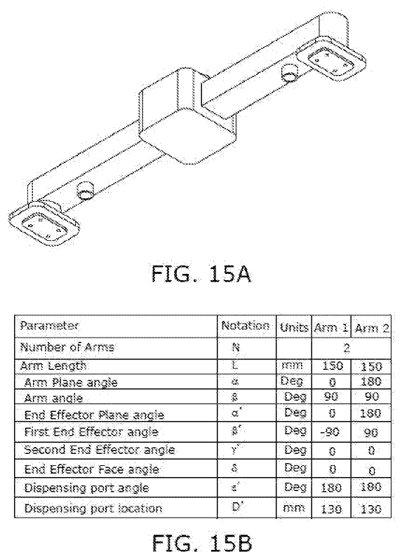

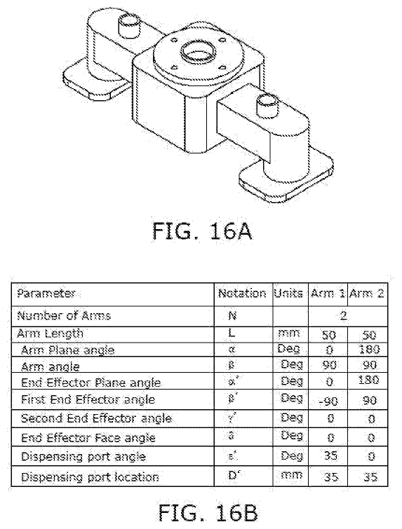

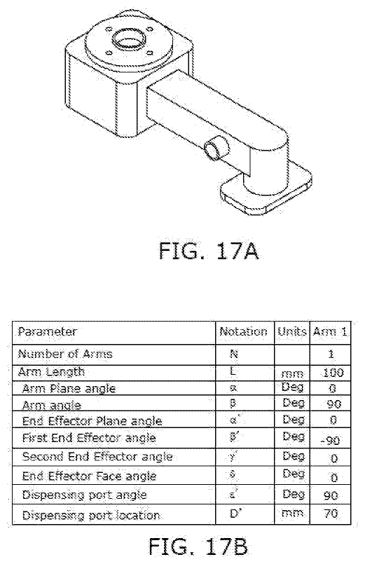

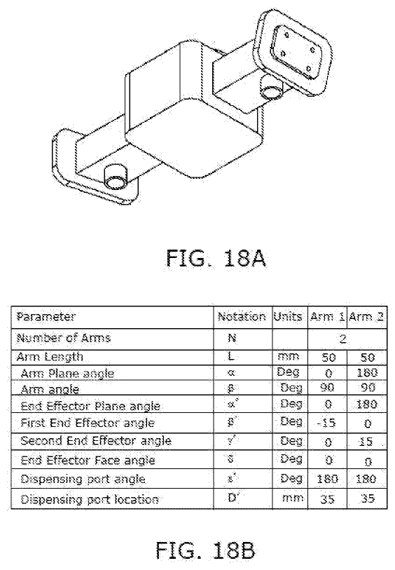

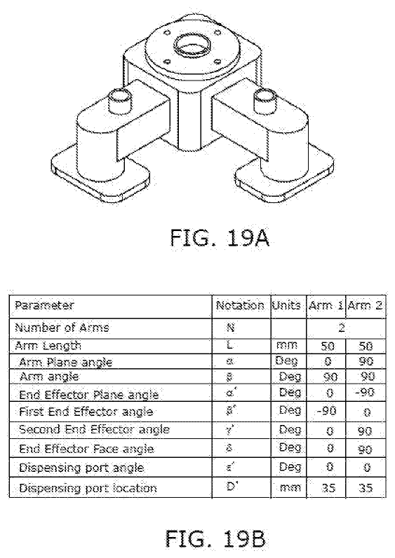

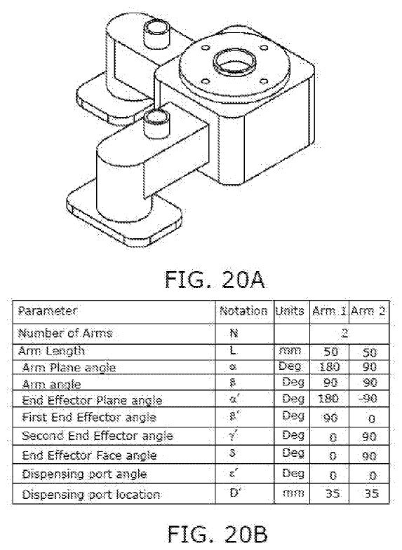

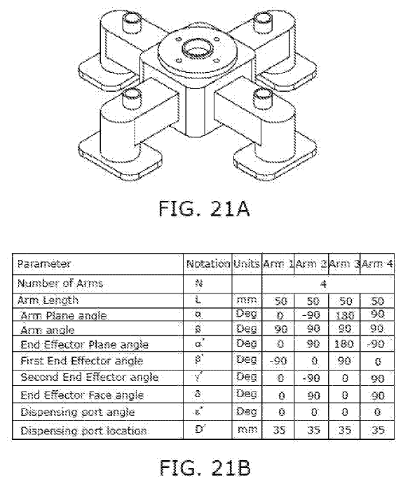

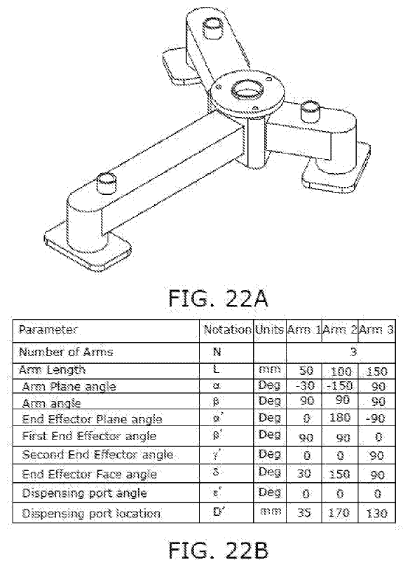

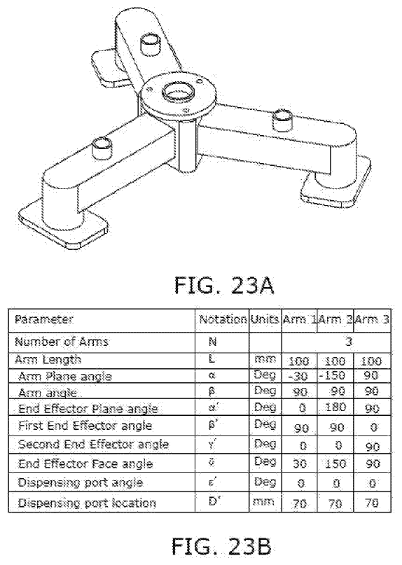

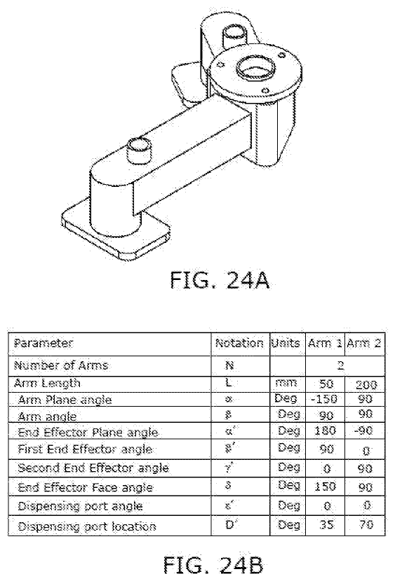

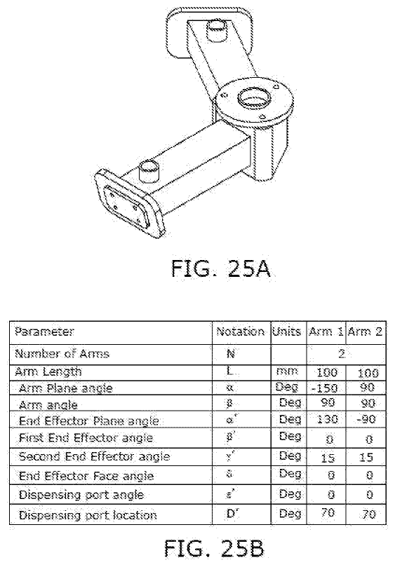

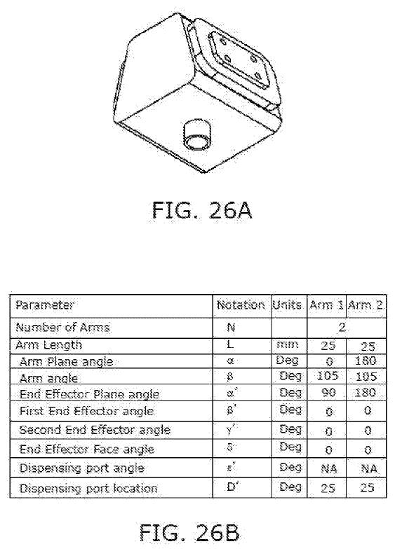

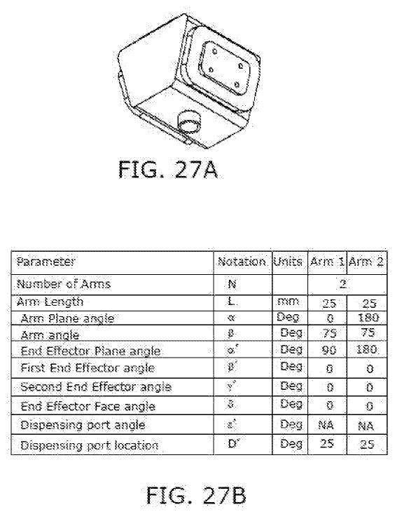

Referring to FIGS. 15A-27B, illustrated are various physical configurations of different pneumatic coupling systems and corresponding tabular representations detailing configuration parameters of the respective pneumatic coupling systems, in accordance with various other embodiments of the present disclosure. Herein, different configurations are obtained by varying at least one configuration parameter of the pneumatic coupling system (such as the pneumatic coupling system 100, 300) as required for the operation. Herein, the configuration parameter includes at least one of number of arms N, a length L of the one or more arms 110, an arm plane angle α, an arm angle β, an end effector plane angle α′, a first end effector angle ε′, a second end effector angle γ′, an end effector face angle δ, a dispensing port location D′ and a dispensing port angle ε′. Beneficially, by changing any one of the configuration parameters a new configuration of the pneumatic coupling system is achieved that may be used to perform a variety of operations present in different situations and locations effectively and efficiently. As shown, each of the table provides the values for the number of arms N, the length L of the one or more arms 110, the arm plane angle α, the arm angle β, the end effector plane angle α′, the first end effector angle β′, the second end effector angle γ′, the end effector face angle δ, the dispensing port location D′ and the dispensing port angle ε′ for the respective configurations, like Table of FIG. 15B for configuration of FIG. 15A, Table of FIG. 16B for configuration of FIG. 16A, and so on.

As an example, referring to FIG. 15A illustrated is a “180-degree configuration” of the pneumatic coupling system, in accordance with an embodiment of the present disclosure. As provided in corresponding table of FIG. 11B, the pneumatic coupling system comprises two numbers of arms (a first arm and a second arm), i.e., N=2. Herein, each arm has an equal length, L=150 mm. Further, the arm plane angle α is 0 degree and 180 degrees for the first arm and the second arm, respectively (thus forming the 180-degree configuration). Further, an arm angle β for each of the first arm and the second arm is 90 degrees in same directions, an end effector plane angle α′ is 0 and 180 degrees for first and second arm, respectively, a first end effector angle β′ is 90 degrees in opposite directions for each arm. Further, the second end effector angle γ′ is 0 degrees for each arm. Also, the end effector face angle δ (representative of docking plate orientation in the pneumatic coupling system) is 0 degrees for each arm. Furthermore, the dispensing port is located at a distance D′ of 130 mm from along the arm axis A and oriented at the dispensing port angle of 180 degrees for each arm.

Other examples as depicted in FIGS. 16A-27B may be understood based on the provided details in the drawings and have not been described herein for the brevity of the present disclosure.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Expressions such as “may” and “can” are used to indicate optional features, unless indicated otherwise in the foregoing. Reference to the singular is also to be construed to relate to the plural.

We claim:

1. A pneumatic coupling system for coupling a mechanical arrangement to one or more end effectors, the pneumatic coupling system comprising:
a central body providing a top face;
a first fastening interface provided in the top face of the central body to allow for releasably coupling a docking plate of the mechanical arrangement thereat;
one or more arms, with one of the one or more arms extending from the central body along an arm axis (A);
a second fastening interface provided in the said one of the one or more arms to allow for releasably coupling a docking plate of one of the one or more end effectors thereat;
a dispensing port associated with the at least one of the one or more arms;
a fluid manifold having a fluid inlet port configured to receive a pneumatic fluid; and
a fluid circuit for each of the one or more arms, disposed in fluid communication with the fluid manifold to receive the pneumatic fluid therefrom, the fluid circuit comprising:
a first fluid outlet line for supplying the pneumatic fluid to the one or more end effectors; and
a second fluid outlet line for supplying the pneumatic fluid to the dispensing port.

2. The pneumatic coupling system as claimed in claim 1, wherein the second fastening interface is provided at a length L along the arm axis (A) from the central body, with the length L varying in a range of 1 millimetre to 1000 millimetres.

3. The pneumatic coupling system as claimed in claim 1, wherein the top face is disposed in a XY plane, defined by a X axis and a Y axis of a first coordinate system with a Z axis perpendicular to the X axis and the Y axis therein, and wherein for each of the one or more arms:
an arm plane angle (α) of the corresponding arm axis (A) defined by rotation of the XY plane about the Z axis of the first coordinate system, varies in a range of 0 degrees to 360 degrees, and
an arm angle (β) of the corresponding arm axis (A) defined by rotation of a XZ plane about the Y axis of the first coordinate system, varies in a range of −165 degrees to +165 degrees.

4. The pneumatic coupling system as claimed in claim 3, wherein for each of the one or more arms, the arm axis (A) defines a Z′ axis of a second coordinate system with a X′ axis and a Y′ axis perpendicular to the Z′ axis, and a X′Z′ plane defining a plane for the second fastening interface therein, and wherein for the corresponding one of the one or more end effectors:
an end effector plane angle (α′) defined by rotation of a X′Y′ plane about the Z′ axis of the second coordinate system, varies in a range of −165 degrees to +165 degrees,
a first end effector angle (β′) defined by rotation of the X′Z′ plane about the Y′ axis of the second coordinate system, varies in a range of −165 degrees to +165 degrees, and
a second end effector angle (γ′) defined by rotation of the Y′Z′ plane about the X′ axis of the second coordinate system, varies in a range of −165 degrees to +165 degrees.

5. The pneumatic coupling system as claimed in claim 4, wherein for the corresponding one of the one or more end effectors, an end effector face angle (δ) defined by rotation of the corresponding one of the one or more end effectors about the Z′ axis of the second coordinate system, varies in a range of 0 degrees to 360 degrees.

6. The pneumatic coupling system as claimed in claim 1, wherein the dispensing port is provided in each of the at least one of the one or more arms, disposed between the central body and the second fastening interface therein.

7. The pneumatic coupling system as claimed in claim 1 further comprising a liquid fluid port configured to receive a liquid fluid, and wherein the fluid circuit is configured to supply the liquid fluid to the dispensing port of the corresponding arm to be dispensed thereby.

8. The pneumatic coupling system as claimed in claim 1, wherein the fluid circuit further comprises one or more isolation valves to regulate the supply of the pneumatic fluid or the liquid fluid to the first fluid outlet line and the second fluid outlet line.

9. The pneumatic coupling system as claimed in claim 1, wherein the fluid circuit further comprises:
one or more control valves associated with each of the first fluid outlet line and the second fluid outlet line to regulate the supply of the pneumatic fluid therein; and
one or more isolation valves to segregate the supply of the pneumatic fluid to the first fluid outlet line and the second fluid outlet line.

10. The pneumatic coupling system as claimed in claim 1 further comprising:
a communication line disposing the controller in signal communication with the mechanical arrangement,
wherein the controller receives control signals indicative of operation of the mechanical arrangement via the communication line, and the controller is configured to regulate the supply of the pneumatic fluid to each of the first fluid outlet line and the second fluid outlet line based on the control signals received thereby, and
wherein the controller transmits control signals to the mechanical arrangement indicative of one or more of a current position and a current orientation of the one or more end effectors associated therewith.
